(19) United States
(12) Patent Application Publication
(10) Pub. No.: US 2025/0321522 A1
(43) Pub. Date: Oct. 16, 2025

(54) FIXING DEVICE AND IMAGE FORMING APPARATUS

(71) Applicant: KYOCERA Document Solutions Inc., Osaka (JP)

(72) Inventors: Hiroki KAWASAKI, Osaka (JP); Ryohei TOKUNAGA, Osaka (JP); Kenichi KASAMA, Osaka (JP); Takashi MIYAKE, Osaka (JP); Akihiro KONDO, Osaka (JP); Shunsaku FUJII, Osaka (JP); Rina KIKUGAWA, Osaka (JP); Yuto MASAOKA, Osaka (JP)

(73) Assignee: KYOCERA Document Solutions Inc., Osaka (JP)

(21) Appl. No.: 19/097,341

(22) Filed: Apr. 1, 2025

(30) Foreign Application Priority Data
Apr. 12, 2024 (JP) 2024-064538

(51) Int. Cl. G03G 15/20

(52) U.S. Cl. CPC G03G 15/2057; G03G 15/2064; G03G 2215/2025

(57) ABSTRACT

A fixing device included a fixing belt, a pressing roller, and a holder. The fixing belt heats a toner on a medium. The pressing member forms a pressure region with the fixing belt and pressurizes the toner on the medium passing through the pressure region while rotating around an axis. The holder is provided inside the fixing belt, has a sliding surface coming into contact with an inner circumferential surface of the fixing belt via lubricant, and holds a heater for heating the fixing belt. A plurality of slits formed into a recess is formed on the sliding surface corresponding to a range excluding the pressure region, side by side in an axial direction. The slits guide a movement of the lubricant from an upstream to a downstream in a rotational direction of the fixing belt. The fixing belt has a hardness capable of restricting deformation such as falling into the slits.

### INCORPORATION BY REFERENCE

This application is based on and claims the benefit of priority from Japanese patent application No. 2024-064538 filed on Apr. 12, 2024, which is incorporated by reference in its entirety.

### BACKGROUND

The present disclosure relates to a fixing device which fixes a toner image to a medium and an image forming apparatus.

There is known a fixing device including a fixing belt and a pressing roller coming into contact with the fixing belt to form a nip. A nip forming member is arranged inside the fixing belt, and lubricant is applied between the inner circumferential surface of the fixing belt and the sliding surface of the nip forming member. A plurality of inclined grooves is formed on the sliding surface of the nip forming member for transferring the lubricant to the center side in the axial direction (width direction).

In the fixing device described above, the inclined grooves and the portions without the inclined grooves are arranged alternately in the axial direction on the sliding surface to form a concave and convex shape. When the fixing belt is made of soft material, it tends to fall into the inclined grooves (slits), and the fixing belt may be deformed in a wavy manner in the axial direction along the concave and convex shape on the sliding surface. The lubricant is not uniformly applied to the inner circumferential surface of the fixing belt deformed in the wavy manner, and friction between the fixing belt and the sliding surface may increase. In addition, in the fixing belt deformed in the wavy manner, the pressure at the nip becomes uneven in the axial direction, so that the fixing state of the image on the sheet may become uneven in the axial direction. Therefore, the image quality may be poor, such as streaks (stripes) in the image fixed on the sheet.

### SUMMARY

A fixing device according to the present disclosure included a fixing belt, a pressing roller, and a holder. The fixing belt is formed in a cylindrical shape and rotates around an axis to heat a toner on a medium. The pressing member forms a pressure region with the fixing belt and pressurizes the toner on the medium passing through the pressure region while rotating around an axis. The holder is provided inside the fixing belt, has a sliding surface coming into contact with an inner circumferential surface of the fixing belt via lubricant, and holds a heater for heating the fixing belt. A plurality of slits formed into a recess is formed on the sliding surface corresponding to a range excluding the pressure region, side by side in an axial direction. The slits guide a movement of the lubricant from an upstream to a downstream in a rotational direction of the fixing belt. The fixing belt has a hardness capable of restricting deformation such as falling into the slits.

An image forming apparatus according to the present disclosure includes the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (side view) showing an internal structure of an image forming apparatus according to one embodiment of the present disclosure.

FIG. 2 is a perspective view showing a fixing device according to one embodiment of the present disclosure.

FIG. 3 is a cross-sectional view taken along the line III-III of FIG. 2.

FIG. 4 is a front view showing the fixing device according to the embodiment of the present disclosure.

FIG. 5 is a rear view showing the fixing device according to the embodiment of the present disclosure.

FIG. 6 is a table showing experimental results for confirming the influence of the Young's modulus of the fixing belt on the fixed image on the sheet, in the fixing device according to the embodiment of the present disclosure.

### DETAILED DESCRIPTION

Hereinafter, with the attached drawings, embodiments of the present disclosure will be described. Fr, Rr, L, R, U and D shown in the drawings indicate the front, rear, left, right, upper and lower. The front-and-rear direction (passing direction), the left-and-right direction (axial direction) and the upper-and-lower direction are orthogonal to each other. Although terms showing directions and positions are used herein, these terms are used for convenience of description and do not limit the technical scope of the present disclosure. The terms “upstream”, “downstream” and the like refer to the “upstream”, “downstream” and the like in the passing direction (conveyance direction) of the paper P (medium). In each of the figures, the dimensions and angles of the members are not accurate and are schematized for the sake of illustration.

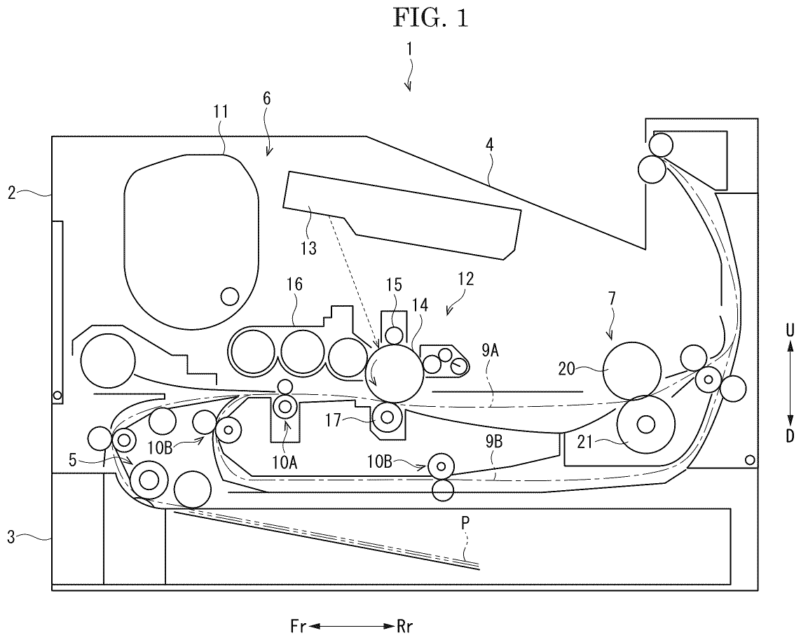

With reference to FIG. 1, the image forming apparatus 1 according to the embodiment will be described. FIG. 1 is a schematic view (side view) showing the image forming apparatus 1.

The image forming apparatus 1 is an electrophotographic printer. The image forming apparatus 1 is provided with an apparatus main body 2 constituting a substantially rectangular parallelepiped appearance. In the lower portion in the apparatus main body 2, a paper feeding cassette 3 in which a paper P (medium) is stored is detachably provided. On the upper surface of the apparatus main body 2, a paper discharge tray 4 is provided. The paper P as an example of the medium is not limited to a paper but may be a resin sheet or the like.

The image forming apparatus 1 includes a paper feeding device 5, an image forming device 6, and a fixing device 7. The paper feeding device 5 is provided at the upstream end of a conveyance path 9A extending from the paper feeding cassette 3 to the paper discharge tray 4, and feeds the paper P stored in the paper feeding cassette 3 to the conveyance path 9A one by one. The image forming device 6 is provided in the middle portion of the conveyance path 9A, and forms a toner image on the conveyed paper P. The fixing device 7 is provided on the downstream side portion of the conveyance path 9A, and thermally fixes the toner image to the paper P.

On the conveyance path 9A, a pair of registration rollers 10 for temporarily blocking the conveyed paper P and correcting the skew of the paper P (skew correction) is provided. An inversion conveyance path 9B is provided below the conveyance path 9A, which branches from the downstream portion of the conveyance path 9A and merges with the upstream portion of the conveyance path 9A. On the inversion conveyance path 9B, a plurality of pairs of conveying rollers 10B for conveying the paper P is provided.

The image forming device 6 includes a toner container 11, a drum unit 12, and an optical scanner 13. The toner container 11 is disposed in the front upper portion in the apparatus main body 2, and contains, for example, black toner (developer). The drum unit 12 includes a photosensitive drum 14, a charging device 15, a developing device 16, and a transfer roller 17. The photosensitive drum 14 is formed in a substantially cylindrical shape, and is driven to be rotated around an axis by a motor (not shown). The charging device 15, the developing device 16 and the transfer roller 17 are arranged around the photosensitive drum 14 in the order of the image forming process. The transfer roller 17 is in contact with the photosensitive drum 14 from the lower side to form a transfer nip. The optical scanner 13 is provided above the photosensitive drum 14, and emits scanning light toward the surface of the photosensitive drum 14.

[Image Forming Process] The operation of the image forming apparatus 1 will be described. A control device (not shown) for controlling the image forming apparatus 1 performs the image forming process based on image data input from an external terminal as follows.

The charging device 15 charges the surface of the photosensitive drum 14, and the optical scanner 13 emits the scanning light based on the image data to form an electrostatic latent image on the photosensitive drum 14. The developing device 16 develops the electrostatic latent image to a toner image on the photosensitive drum 14 by using the toner supplied from the toner container 11. The paper feeding device 5 feeds the paper P one by one from the paper feeding cassette 3 to the conveyance path 9A. The paper P is conveyed along the conveyance path 9A, the skew of the paper P is corrected by the pair of registration rollers 10A, and then the paper P enters the transfer nip. The transfer roller 17 transfers the toner image on the photosensitive drum 14 to the surface of the paper P passing through the transfer nip. The fixing device 7 thermally fixes the toner image to the paper P. In the case of single-sided printing, the paper P which has passed through the fixing device 7 is discharged to the paper discharge tray 4.

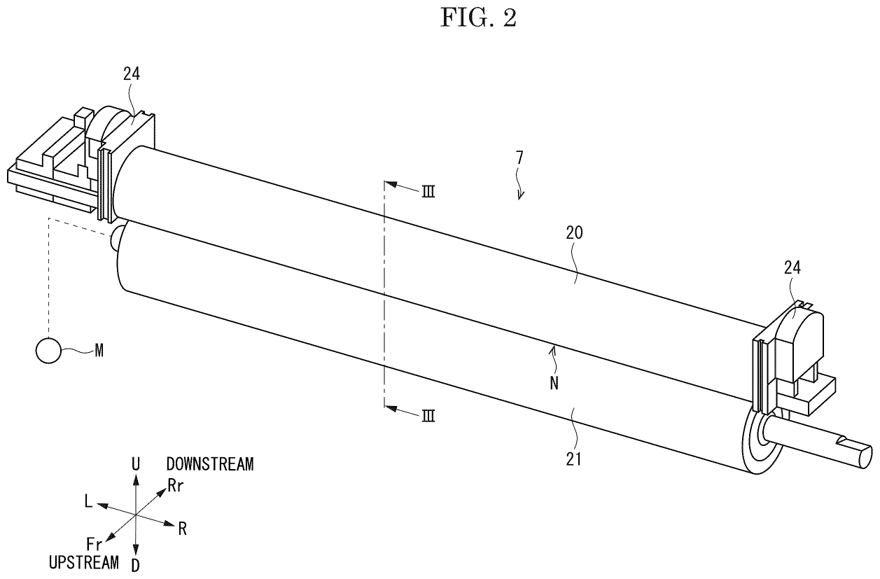

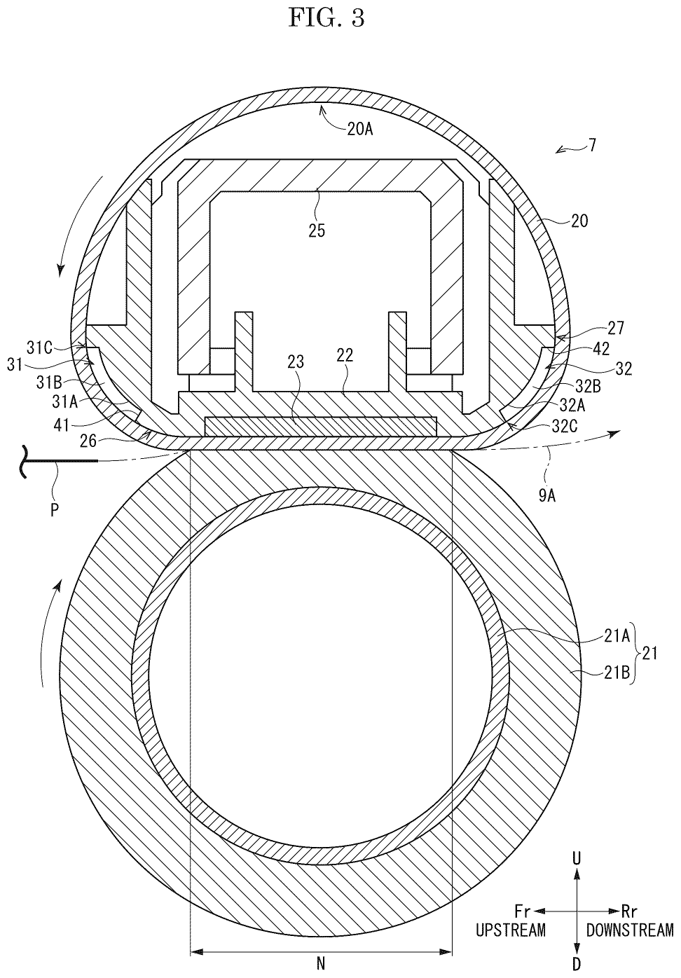

In the case of double-sided printing, the paper P which has passed through the fixing device 7 is switched back at the downstream end of the conveyance path 9A, and sent to the inversion conveyance path 9B. The paper P is conveyed by the pairs of conveying rollers 10B, returned from the inversion conveyance path 9B to the conveyance path 9A again, and sent to the transfer nip after the skew correction by the pair of registration rollers 10A. Thereafter, the toner image is transferred to the paper P, thermally fixed, and the double-sided printed paper P is discharged to the paper discharge tray 4.

[Fixing Device] With reference to FIG. 2 and FIG. 3, the fixing device 7 will be described in detail. FIG. 2 is a perspective view showing the fixing device 7. FIG. 3 is a cross-sectional view taken along the line III-III of FIG. 2.

The fixing device 7 includes a fixing belt 20, a pressing roller 21, a heater holder 22, and a heater 23. The fixing belt 20 and the pressing roller 21 are supported by a frame (not shown), and the frame is fixed to the apparatus main body 2. The heater holder 22 is provided inside the fixing belt 20, and the heater 23 is held by the heater holder 22 (see FIG. 3).

<Fixing Belt> The fixing belt 20 is an endless belt formed in a substantially cylindrical shape elongated in the left-and-right direction (axial direction). The fixing belt 20 is made of material having heat resistance and flexibility (polymer resin or metal, or combination of polymer resin and metal). A pair of holding members 24 (see FIG. 2) are inserted into both right and left ends of the fixing belt 20. The pair of holding members 24 guide the fixing belt 20 rotatably around an axis while holding the fixing belt in a substantially cylindrical shape. The fixing belt 20 is supported by the frame via the pair of holding members 24 (not shown).

<Pressing Roller> The pressing roller 21 as an example of the pressing member is formed in a substantially cylindrical shape elongated in the left-and-right direction. The pressing roller 21 includes a metal core 21A and an elastic layer 21B such as a silicon sponge laminated on the outer circumferential surface of the metal core 21A (see FIG. 3). A drive motor M is connected to the left end of the metal core 21A via a gear train (not shown) (see FIG. 2). The pressing roller 21 comes into contact with the fixing belt 20 from the lower side, and forms a pressure region N between the fixing belt 20 and the fixing belt. The pressure region N refers to a region from an upstream position where the pressure is 0 Pa to a downstream position where the pressure becomes 0 Pa again via a position where the pressure acts.

<Heater Holder> As shown in FIG. 3, the heater holder 22 (holder) is supported by a support member 25 inside the fixing belt 20. The support member 25 is made of, for example, metallic material such as stainless steel, and formed in a substantially rectangular cylindrical shape elongated in the left-and-right direction (axial direction), and is provided between the pair of holding members 24. The heater holder 22 is fixed to the lower portion of the support member 25. The heater holder 22 is made of, for example, synthetic resin having heat resistance and wear resistance, and is formed in a substantially semi-cylindrical shape elongated in the left-and-right direction. The heater holder 22 is in contact with the lower side portion (on the side of the pressure region N) of the inner circumferential surface 20A of the fixing belt 20.

<Heater> The heater 23 is formed in a substantially rectangular plate shape elongated in the left-and-right direction, and is fixed (held) to the lower surface of the heater holder 22. The heater 23 has a heating resistor (not shown) laminated on a base board, and generates heat by energizing the heating resistor. The heating resistor of the heater 23 is brought into contact with the inner circumferential surface 20A of the fixing belt 20 at a position corresponding to the pressure region N.

The frame supporting the fixing belt 20 and the others is provided with a temperature sensor (not shown) for detecting a surface temperature of the fixing belt 20. The drive motor M, the heater 23, the temperature sensor, and the others are electrically connected to the control device of the image forming apparatus 1 via various drive circuits (not shown), and are appropriately controlled.

[Operation of Fixing Device] Here, the operation (fixing process) of the fixing device 7 will be described. The pressing roller 21 is rotated by receiving the driving force of the drive motor M, and the fixing belt 20 is rotated in accordance with the pressing roller 21 (see the arrow in FIG. 3). The heater 23 heats the fixing belt 20. The control device receives a detection signal from the temperature sensor, and starts performing the image forming process described above while controlling the heater 23 to maintain the predetermined temperature.

The paper P on which the toner image is transferred enters the pressure region N. The fixing belt 20 heats the toner (toner image) on the paper P passing through the pressure region N while rotating around the axis. The pressing roller 21 pressurizes the toner on the paper P passing through the pressure region N while rotating around the axis. Then, the toner image is fixed to the paper P, and the fixed image is formed on the paper P. The paper P on which the image is fixed is discharged to the paper discharge tray 4.

[Heater Holder Details] As shown in FIG. 3, the heater holder 22 has sliding surfaces 26, 27 in contact with the inner circumferential surface 20A of the fixing belt 20 on the upstream side and the downstream side of a portion for holding the heater 23 (a position corresponding to the pressure region N). In this specification, for convenience of explanation, the sliding surface 26 on the upstream side of the pressure region N is referred to as the “first sliding surface 26”, the sliding surface 27 on the downstream side of the pressure region N is referred to as the “second sliding surface 27”, and the common description of the first sliding surface 26 and the second sliding surface 27 is simply referred to as the “sliding surfaces 26 and 27”.

Lubricant (not shown) is applied to the inner circumferential surface 20A of the fixing belt 20, and the sliding surfaces 26, 27 of the heater holder 22 are in contact with the inner circumferential surface 20A of the fixing belt 20 through the lubricant. The lubricant is grease or the like having viscosity and fluidity, and reduces frictional resistance between the fixing belt 20 and the heater holder 22. Although the lubricant moves with the rotation of the fixing belt 20, it is known that the lubricant moves toward both axially outer sides at a portion where the inner circumferential surface 20A of the fixing belt 20 is not in contact with the sliding surfaces 26, 27. When the lubricant leaks from both axial outer ends of the fixing belt 20 by repeating the fixing process and an amount of the lubricant decreases, the frictional resistance between the fixing belt 20 and the heater holder 22 increases, and there is a possibility that the smooth rotation of the fixing belt 20 is hindered.

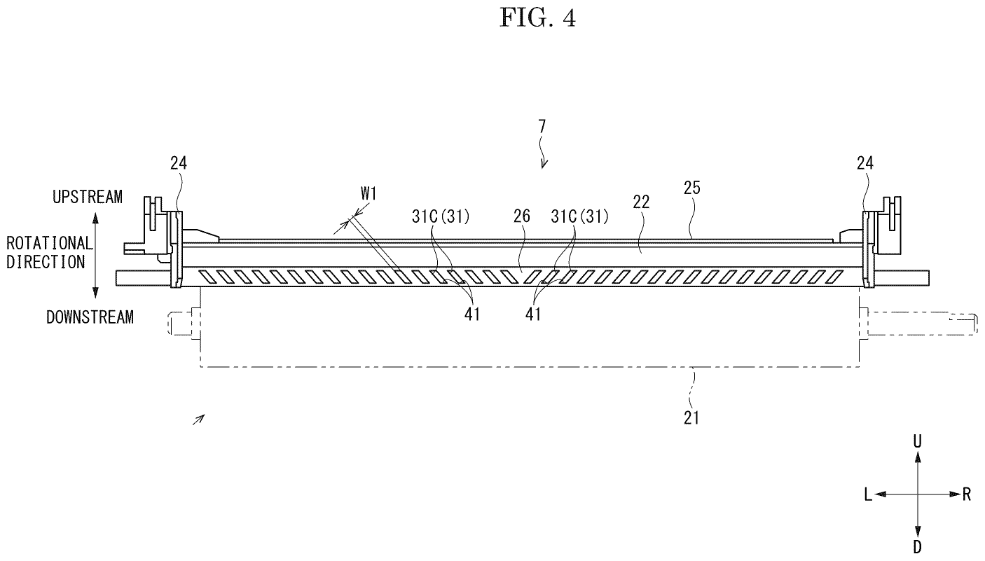

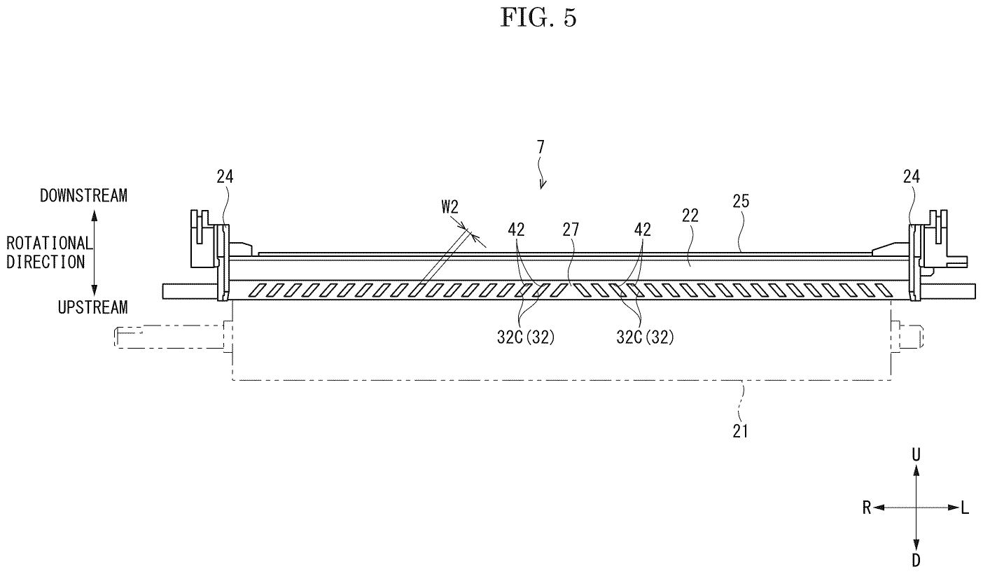

Therefore, the fixing device 7 according to the present embodiment has a structure for suppressing the leakage of the lubricant applied to the inner circumferential surface 20A of the fixing belt 20. With reference to FIG. 3 to FIG. 5, the structure for suppressing the leakage of the lubricant will be described below. FIG. 4 is a front view showing the fixing device 7. FIG. 5 is a rear view showing the fixing device 7. In FIG. 4 and FIG. 5, the fixing belt 20 is not shown.

<Slit> In the heater holder 22, a plurality of slits 31, 32 are arranged in the left-and-right direction (axial direction) on the sliding surfaces 26, 27 corresponding to the ranges excluding the pressure region N. The slits 31, 32 are formed to be recessed in the sliding surfaces 26, 27, respectively, and guide the movement of the lubricant from the upstream to the downstream in the rotational direction of the fixing belt 20. In this specification, for convenience of explanation, the slit 31 (see FIG. 4) formed on the sliding surface 26 on the upstream side of the pressure region N is referred to as the “first slit 31”, the slit 32 (see FIG. 5) formed on the sliding surface 27 on the downstream side of the pressure region N is referred to as the “second slit 32”, and a common description of the first slit 31 and the second slit 32 is simply referred to as the “slits 31, 32”. Further, in order to simplify the description, the description will be made mainly focusing on one first slit 31 and one second slit 32. Further, as described at the beginning, in this specification, the simple term “upstream, downstream” refers to the passing direction (conveyance direction) of the paper P, and is distinguished from the “upstream, downstream” in the rotational direction of the fixing belt 20.

As shown in FIG. 4 and FIG. 5, the slits 31, 32 are grooves extending linearly along the rotational direction of the fixing belt 20. In detail, the slits 31, 32 are inclined toward the center in the left-and-right direction (axial direction) from the upstream to the downstream in the rotational direction of the fixing belt 20. Inclination angles (absolute values) of the slits 31, 32 are all the same, and the slits 31, 32 are arranged symmetrically with respect to the center in the left-and-right direction.

(First Slit) As shown in FIG. 3 and FIG. 4, the first slit 31 has a bottom surface 31A and a peripheral wall surface 31B, and is recessed to form an annular opening edge portion 31C on the first sliding surface 26. The bottom surface 31A and the opening edge portion 31C have an outer shape of a substantially parallelogram, and the peripheral wall surface 31B is formed in a substantially rectangular cylindrical shape so as to connect the peripheral edge of the bottom surface 31A and the opening edge portion 31C. A groove width W1 of the first slit 31 may be, for example, about 1.0 to 6.0 mm. The groove width W1 refers to a length of a line segment perpendicular to the wall surfaces facing each other in the left-and-right direction (axial direction) of the peripheral wall surface 31B (see FIG. 4). The peripheral wall surface 31B forms a step between the bottom surface 31A and the first sliding surface 26. The step is preferably about 0.5 to 2.0 mm, for example. The downstream side wall surface of the peripheral wall surface 31B of the first slit 31 in the rotational direction of the fixing belt 20 serves as a blocking portion 41 for restricting the leakage of the lubricant from the first slit 31. The blocking portion 41 is located on the upstream side of the most upstream end of the pressure region N (the holding portion of the heater 23), and the first sliding surface 26 is also formed between the blocking portion 41 and the most upstream end of the pressure region N.

(Second Slit) As shown in FIG. 3 and FIG. 5, the second slit 32 has a shape such that the first slit 31 is inverted in the upper-and-lower direction. The second slit 32 has a bottom surface 32A and a peripheral wall surface 32B, and is recessed to form an annular opening edge portion 32C on the second sliding surface 27. The downstream side wall surface of the peripheral wall surface 32B in the rotational direction of the fixing belt 20 serves as a blocking portion 42. A groove width W2 (see FIG. 5) and a step of the second slit 32 are the same as the groove width W1 and the step of the first slit 31.

Incidentally, although a distance between any two adjacent slits 31, 32 each inclined in the same direction is substantially equal, it is not limited to this and may be an indefinite distance (not shown). For example, the slits 31, 32 may be formed such that the distance is gradually narrowed or widened outward from the axial center (not shown). Further, although the groove widths W1, W2 of the slits 31, 32 are all the same size, they are not limited to this and may be different sizes. For example, the slits 31, 32 may be formed to gradually narrow or widen the groove widths W1, W2 from the axial center outward (not shown).

[Action of Slit] The lubricant adhering to the inner circumferential surface 20A of the fixing belt 20 moves on the downstream side in the rotational direction with the rotation of the fixing belt 20 to lubricate the fixing belt 20 (the inner circumferential surface 20A) sliding against the first sliding surface 26. The lubricant enters the first slits 31, and moves to the axial center along the first slits 31.

With the rotation of the fixing belt 20, the lubricant lubricates the fixing belt 20 sliding against the heater 23, and when the fixing belt 20 passes through the pressure region N, lubricates the fixing belt 20 sliding against the second sliding surface 27. The lubricant enters the second slits 32, and moves toward the axial center along the second slits 32.

As described above, since the slits 31, 32 are inclined toward the axial center from the upstream to the downstream in the rotational direction of the fixing belt 20, the lubricant can be moved toward the axial center of the heater holder 22. Thus, the leakage of the lubricant from both outer axial ends of the fixing belt 20 can be suppressed. Further, the slits 31, 32 has the blocking portions 41, 42 on the downstream side in the rotational direction of the fixing belt 20. Therefore, although a part of the lubricant moving along the slits 31, 32 passes over the blocking portions 41, 42 and flows out, the remaining lubricant is blocked by the blocking portions 41, 42 and remains in the slits 31, 32. Thus, an amount of lubricant leaking out of the slits 31, 32 can be restricted to be small, and excessive adhesion of the lubricant to the inner circumferential surface 20A of the fixing belt 20 can be suppressed.

In the sliding surfaces 26, 27, the slits 31, 32 and the portions without the slits 31, 32 (between the adjacent slits 31, 32) are arranged alternately in the axial direction to form a concave and concave shape. If the fixing belt 20 is made of soft material, it tends to fall into the slits 31, 32, and may be deformed in a wavy manner in the axial direction along the convex and concave shape formed on the sliding surfaces 26, 27. And, the lubricant is not uniformly adhered to the inner circumferential surface 20A of the fixing belt 20 deformed in the wavy manner, and the friction between the fixing belt 20 and the sliding surfaces 26, 27 may increase. Further, in the fixing belt 20 deformed in the wavy manner, the pressure in the pressure region N becomes uneven in the axial direction, and therefore, the fixing state of the image on the paper P may become uneven in the axial direction. Therefore, the image quality may be poor such as streaks (stripes) in the image fixed to the paper P. Further, when the fixing belt 20 deformed in the wavy manner rotates, a force to move the fixing belt 20 in the axial direction acts, and it is considered that the end of the fixing belt 20 comes into contact with the holding member 24 and is damaged.

In the fixing device 7 according to the present embodiment, the fixing belt 20 has a hardness capable of restricting the deformation such as falling into the slits 31, 32. More specifically, the fixing belt 20 is made of polymeric resin such as polyimide or metal such as nickel or stainless steel, and preferably has a hardness of Young's module 7 GPa or higher. More specifically, the Young's modulus of the fixing belt 20 is preferably not less than 7.0 GPa and not more than 200 GPa. The Young's modulus of the material of the fixing belt 20 may be adjusted, for example, by adding an additive at the time of manufacturing the polymer resin or the metal.

The Young's modulus of the fixing belt 20 may be correlated with the groove widths W1, W2 of the slits 31, 32. That is, when the groove widths W1, W2 of the slits 31, 32 are narrow (for example, about 1.0 to 3.0 mm), it is considered that the fixing belt 20 is hard to fall into the slits 31, 32, and therefore the Young's modulus may be set low (for example, about 7 to 10 GPa). On the other hand, when the groove widths W1, W2 of the slits 31, 32 are wide (for example, about 3.0 to 6.0 mm), the fixing belt 20 is likely to fall into the slits 31, 32, and therefore, the Young's modulus of the fixing belt may be set high (for example, about 10 to 200 GPa).

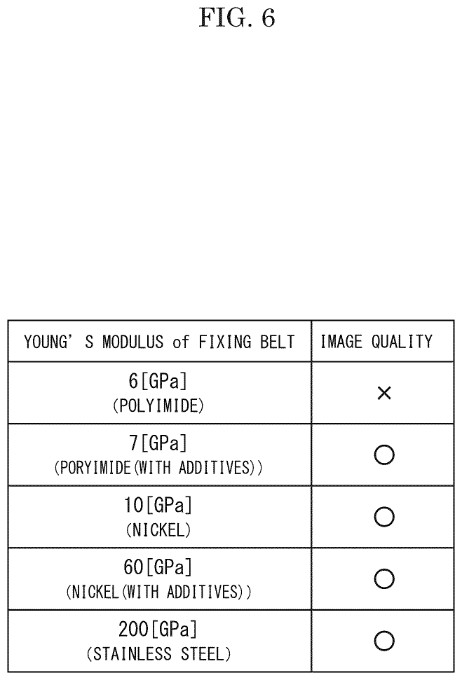

The applicant set the groove widths W1, W2 of the slits 31, 32 to about 3.0 mm, and conducted an experiment to confirm the influence of the Young's modulus of the fixing belt 20 on the fixed image on the paper P. As a result, as shown in FIG. 6, it was confirmed that when the Young's modulus of the fixing belt 20 was set to 6 GPa, streaks (stripes) were generated in the image fixed to the paper P (image evaluation: x), and when the Young's modulus of the fixing belt 20 was set to 7 GPa or more, streaks (stripes) were not generated in the image fixed to the paper P (image evaluation: ∘). The material and Young's modulus of the fixing belt 20 are as shown in FIG. 6.

In the fixing device 7 according to the present embodiment described above, the fixing belt 20 has a hardness (for example, a Young′ modulus 7 GPa or more) capable of restricting the deformation such as falling into the slits 31, 32. According to this configuration, since the fixing belt 20 hardly falls into the slits 31, 32, it is prevented from being deformed in the wavy manner in the axial direction along the convex and concave shape formed on the sliding surfaces 26, 27. That is, the deformation of the fixing belt 20 rotating along the sliding surfaces 26, 27 on which the slits 31, 32 are formed can be suppressed. Thus, the lubricant can be adhered substantially uniformly to the smooth inner circumferential surface 20A of the fixing belt 20. As a result, the increase in friction between the fixing belt 20 and the heater holder 22 can be suppressed, and smooth rotation of the fixing belt 20 can be ensured. Further, since the waving deformation of the fixing belt 20 is suppressed on the upstream and downstream sides of the pressure region N, the pressure in the pressure region N can be made generally uniform in the axial direction. Thus, the fixing state of the image on the paper P is stabilized, and the occurrence of poor image quality such as the occurrence of stripes on the image can be suppressed. Further, since the force for moving the fixing belt 20 in the axial direction with the rotation of the fixing belt 20 is hardly applied, the end of the fixing belt 20 is prevented from coming into contact with the holding member 24, and the breakage of the end of the fixing belt 20 can also be prevented.

In the fixing device 7 according to the present embodiment, the Young's modulus of the fixing belt 20 correlates with the groove widths W1, W2 of the slits 31, 32. According to this configuration, when the groove widths W1, W2 of the slits 31, 32 are narrow (for example, 1.0 to 3.0 mm), for example, the fixing belt 20 may be made of flexibly deformable material having the Young's modulus of about 7 to 10 GPa. Thus, the outer diameter of the fixing belt 20 can be reduced (the curvature can be increased), and the fixing device 7 can be miniaturized.

In the fixing device 7 according to the present embodiment, the slits 31, 32 are recessed so as to form the annular opening edge portions 31C, 32C, but the disclosure of the present disclosure is not limited thereto. For example, in the slits 31 and 32 according to the first modified example, the peripheral wall surfaces 31B, 32B may have no wall surfaces on the downstream side in the rotational direction of the fixing belt 20, and the downstream ends of the bottom surfaces 31A, 32A may be formed so as to continue to the sliding surfaces 26, 27 without forming the steps (not shown).

Further, in the fixing device 7 according to the present embodiment, since each of the slits 31, 32 is inclined at the same angle, the lubricant may collect too much at the axial center depending on the inclination angle. Therefore, in the slits 31, 32 according to the second modified example, for example, about one to three slits 31, 32 near the axial center are formed in parallel with the rotational direction of the fixing belt 20, and other slits 31, 32 except for the slits 31, 32 near the axial center may be inclined toward the axial center from the upstream to the downstream in the rotational direction of the fixing belt 20 (not shown). In addition, in the slits 31 and 32 according to the third modified example, the inclination angle with respect to the rotational direction of the fixing belt 20 may be gradually increased from the axial center toward both the axial outer sides (not shown). According to these configurations, the movement direction of the lubricant can be directed toward the center as the slits 31, 32 are located on the axial outer sides. As a result, it is possible to suppress the leakage of the lubricant from both axial outer ends of the fixing belt 20 while suppressing excessive concentration of the lubricant in the axial center.

In the fixing device 7 according to the present embodiment (including the first to third modified examples, the same shall apply hereinafter), the slits 31, 32 are formed on the two sliding surfaces 26, 27, but they are not limited thereto, and may be formed on only one of the sliding surfaces 26, 27, for example (not shown). In addition, for example, the slits 31, 32 having the annular opening edge portions 31C, 32C are formed on the sliding surface 26, and the slits 31, 32 according to the first modified example are formed on the sliding surface 27, and various slits 31, 32 including the first to third modified example may be freely combined and formed on the sliding surfaces 26, 27 (not shown).

In the fixing device 7 according to the present embodiment, the slits 31 to 34 are formed in a linear line, but they are not limited thereto, and may be curved (not shown). Further, the slits 31, 32 may be formed so as to be parallel to the rotational direction of the fixing belt 20 (or the passing direction of the sheet P) without being inclined (not shown).

In the description of the above-described embodiment, the present disclosure is applied to the monochrome image forming apparatus 1 as an example, but the present disclosure is not limited thereto, and the present disclosure may be applied to, for example, a color printer, a copying machine, a facsimile machine, or a multifunctional peripheral.

It should be noted that the description of the above embodiments shows one aspect of the fixing device and the image forming apparatus according to the present disclosure, and the technical range of the present disclosure is not limited to the above embodiments. The present disclosure may be varied, replaced, and modified without departing from the spirit of the technical thought, and the scope of the claims includes all embodiments that may be included within the scope of the technical thought.

1. A fixing device comprising:
a fixing belt formed in a cylindrical shape and rotating around an axis to heat a toner on a medium;
a pressing member forming a pressure region with the fixing belt and pressurizing the toner on the medium passing through the pressure region while rotating around an axis; and
a holder which is provided inside the fixing belt, has a sliding surface coming into contact with an inner circumferential surface of the fixing belt via lubricant, and holds a heater for heating the fixing belt, wherein
a plurality of slits formed into a recess is formed on the sliding surface corresponding to a range excluding the pressure region, side by side in an axial direction,
the slits guide a movement of the lubricant from an upstream to a downstream in a rotational direction of the fixing belt, and
the fixing belt has a hardness capable of restricting deformation such as falling into the slits.

2. The fixing device according to claim 1, wherein
the fixing belt has a hardness of Young's modulus 7 GPa or higher.

3. The fixing device according to claim 2, wherein
the Young's modulus of the fixing belt correlates with a groove width of the slit, and
the groove width is set to 1.0 to 3.0 mm when the Young's modulus of the fixing belt is 10 GPa or less.

4. An image forming apparatus comprising the fixing device according to claim 1.
